(19) United States
(12) Patent Application Publication
(10) Pub. No.: US 2012/0086877 A1
(43) Pub. Date: Apr. 12, 2012

(54) SENSOR-ACTIVATED STILL AND VIDEO IMAGE DISPLAY

(76) Inventor: Andy K. F. Kaoh, Santa Ana, CA (US)

(21) Appl. No.: 13/253,773

(22) Filed: Oct. 5, 2011

Related U.S. Application Data
(60) Provisional application No. 61/390,540, filed on Oct. 6, 2010.

(51) Int. Cl. H04N 5/64; H04N 5/66

(52) U.S. Cl. 348/836; 348/739; 348/E05.133; 348/E05.128

(57) ABSTRACT

An electronic display (e.g., a LCD) may be built inside a picture frame. The picture frame may include an opening the same size of the electronic display to enable a viewer to view both the picture frame and the electronic display. The electronic display may include a media player storing the still picture and video data, and a sensor. The electronic display may default to displaying the still picture. However, upon the sensor detecting a person approaching, the still picture may be replaced with a video to be played to the approaching person thereby engaging the person. After the video has been played, the electronic display may return to displaying the still picture until the next approaching person is detected, or alternatively may continue to play video until the sensor detects that there are no persons within the detection range.

### CROSS-REFERENCE

This application claims the benefit of U.S. Provisional Patent Application No. 61/390,540, filed Oct. 6, 2010, the contents of which are incorporated herein by this specific reference.

### BACKGROUND OF THE INVENTION

1. Field of the Invention

This application generally relates to a display with a picture portion and an animation portion. While the picture portion remains static, the animation portion can transform from a displayed picture to an animation or video upon detecting that a person is within a predetermined distance from the display.

2. Description of Related Art

Digital picture frames that display still photos are currently available in the market. These digital picture frames typically display digital photos and might even display a slideshow of all the photos saved onto a memory card attached to the digital picture frame. However, these digital picture frames remain static and do not offer any interaction with the viewer. Indeed, at most, the viewer is able to control the speed by which the pictures are displayed (by changing a display setting) and the order that these pictures are displayed (e.g., randomized or sequential). Such digital frames do not engage the viewer other than with the still pictures themselves. As such, the information provided to the viewer is limited to the image itself.

What is needed is an improvement on picture frame technology which engages the viewer in a way that is much more memorable than a standard still photo. Accordingly, the devices, systems and methods described herein are directed to the same.

### SUMMARY OF THE INVENTION

This invention consists of an electronic display, e.g., a liquid crystal display (LCD), that is built inside a picture frame. The picture frame can include an opening the same size of the electronic display to enable the viewer to see both the picture frame and the electronic display. The electronic display can further include a media player storing the still picture and video data, and a sensor. In normal operation, the electronic display defaults to showing a still picture. When the sensor detects that a person (e.g., a viewer) is within a predetermined distance from the display, the still picture is replaced with a video to be played to the approaching viewer. After the video has been played and/or when the sensor determines that the person is no longer in range, the electronic display returns to displaying the still picture until the next approaching person is detected.

In one embodiment, the picture frame is a snap picture frame which allows a user to insert a printed picture with a “cut-out” portion to allow the LCD to be seen by a viewer. The still picture displayed by the LCD is the “missing” part of the printed picture. In this manner, a viewer might not detect that the LCD displaying the picture is actually a separate component, but is instead led to believe that the LCD portion is simply part of the printed picture and that the entire picture is one complete photo. The LCD portion is thus camouflaged and unknown to the user as a different portion. When the sensor is triggered, the LCD begins to play the video, thereby surprising the approaching viewer and making a lasting impression on the viewer. In one aspect, the playing of the video is accompanied by corresponding audio such as a recorded voice, music, or other noise to further engage the viewer.

In another embodiment, the snap picture frame is versatile. The frame can be unsnapped or opened, e.g., the printed picture with the cut out portion can be removed and a new printed picture with a cut out portion could be inserted in its place and the frame snapped back or closed in position to hold the new picture. The LCD displaying the “missing” part of the picture can also be re-programmed to display the missing part of the new picture and can further be re-programmed to display a new video and output a new audio to correspond with the new video and new picture. The LCD display is easily reprogrammed, for example, by inserting a memory card storing the new video and audio data. Alternatively, a memory card could contain multiple different videos and the operator can easily switch to different corresponding printed pictures.

In another embodiment, the picture frame is a digital picture frame with two display portions, with a first display portion embedded inside a second display portion. The first display portion can allow a user to select a first still picture and a motion video. The second display portion can allow a user to select a second still picture. The selected first still picture is configured to be the “missing” part of the second still picture. Similarly, when the sensor is triggered, the LCD replaces the selected first still picture with a video and begins playing the video in the first display portion, thereby surprising the approaching viewer and making a lasting impression on the viewer. In one aspect, the playing of the video can include an audio portion as well such as a recorded voice, music, or other noise to further engage the viewer. This embodiment could also include a scroll function where different still pictures can be selected for the first and second display portions, and for each different still picture selected, a corresponding video can be selected such that when the viewer triggers the sensor, the corresponding video is played in the first display portion while the second display portion stays the same, displaying the still picture.

In one embodiment, a picture display system is provided comprising: a picture frame having a picture-holding component; a picture configured to be held in place within the picture frame by the picture-holding component, the picture having a cut-out portion; an electronic display portion attached to the picture frame at the location of the cut-out portion; and a sensor coupled to the electronic display portion, the sensor configured to detect a presence of a person within a detection range of the sensor, wherein the electronic display portion is configured to display a video when the sensor detects the presence of the person within the detection range, and the electronic display portion is configured to display a still image when the sensor does not detect the presence of a person within the detection range.

In another embodiment, apparatus for camouflaging a portion of picture as a still image and replacing the still image with a video and upon detection of a person, the apparatus is provided, comprising: a base for supporting a picture; a frame attached to the edge of the base configured to hold the picture to the base; an electronic display portion within the base; a sensor coupled to the electronic display portion, the sensor configured to detect a presence of a person within a detection range of the sensor, wherein the electronic display portion is configured to display the video when the sensor detects the presence of the person within the detection range, and wherein the electronic display portion is configured to display the still image when the sensor does not detect the presence of a person within the detection range.

In another embodiment, a method of replacing a still image with a video is provided, comprising: displaying a still image on an electronic display within a picture frame; detecting a presence of a person using a sensor coupled to the electronic display; in response to detecting the presence of a person, replacing the still image on the electronic display with the video; and playing the video on the electronic display until the video is over or until the sensor determines that the person is no longer present.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1A is an example of a frame with a printed picture and an electronic display portion that blends into the printed picture when in still mode in accordance with one more or more aspects described herein.

FIG. 1B is an example of a snapshot of a frame with a printed picture and an electronic display portion displaying video in accordance with one more or more aspects described herein.

FIG. 1C is an example of a snapshot of a frame with a printed picture and an electronic display portion displaying video in accordance with one more or more aspects described herein.

FIG. 1D is an example of a snapshot of a frame with a printed picture and an electronic display portion displaying video in accordance with one more or more aspects described herein.

FIG. 1E is an example of a printed picture and a separate frame with an electronic display portion capable of displaying a still picture in accordance with one more or more aspects described herein.

FIG. 1F is an example of a close-up, perspective view of a portion of a frame that is flipped “open” as to enable the insertion or removal of a printed picture within the frame in accordance with one or more aspects described herein.

FIG. 1G is an example of a close-up view of a portion of a frame that is in a “closed” position to hold a printed picture in place within the frame in accordance with one or more aspects described herein.

FIG. 1H is an example of a back view of a frame in accordance with one or more aspects described herein.

FIG. 1I is an example of a frame with an electronic display portion with a sensor trigger range in accordance with one or more aspects described herein.

FIG. 2 is an example of a block diagram of an electronic display in accordance with one more or more aspects described herein.

FIG. 3 is another example of a block diagram of an electronic display in accordance with one more or more aspects described herein.

FIG. 4A is an example of a frame with a still picture portion and an electronic display portion that blends into the still picture portion when in still mode in accordance with one more or more aspects described herein.

FIG. 4B is an example of a snapshot of a still picture portion and an electronic display portion displaying video in accordance with one more or more aspects described herein.

FIG. 4C is an example of a snapshot of a still picture portion and an electronic display portion displaying video in accordance with one more or more aspects described herein.

FIG. 4D is an example of a snapshot of a still picture portion and an electronic display portion displaying video in accordance with one more or more aspects described herein.

FIG. 5 is a flowchart of the operation of the frame with a still or printed picture and an electronic display portion in accordance with one more or more aspects described herein.

### DETAILED DESCRIPTION OF THE PREFERRED EMBODIMENTS

Apparatus, systems and methods that implement the embodiments of the various features of the present invention will now be described with reference to the drawings. The drawings and the associated descriptions are provided to illustrate some embodiments of the present invention and not to limit the scope of the present invention. Throughout the drawings, reference numbers are re-used to indicate correspondence between referenced elements.

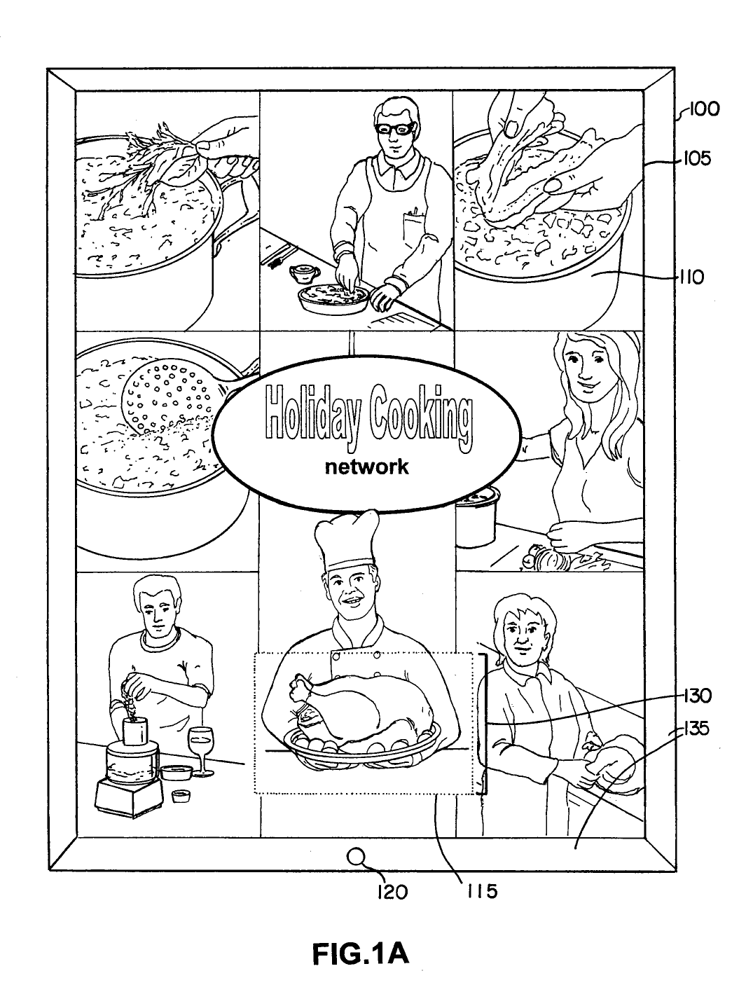

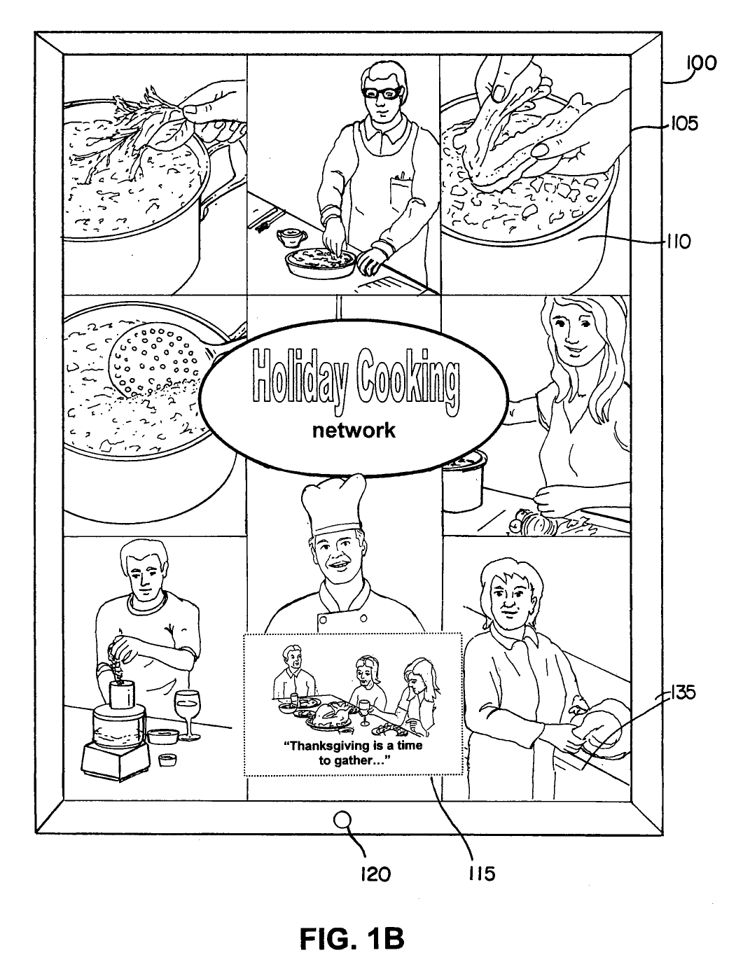

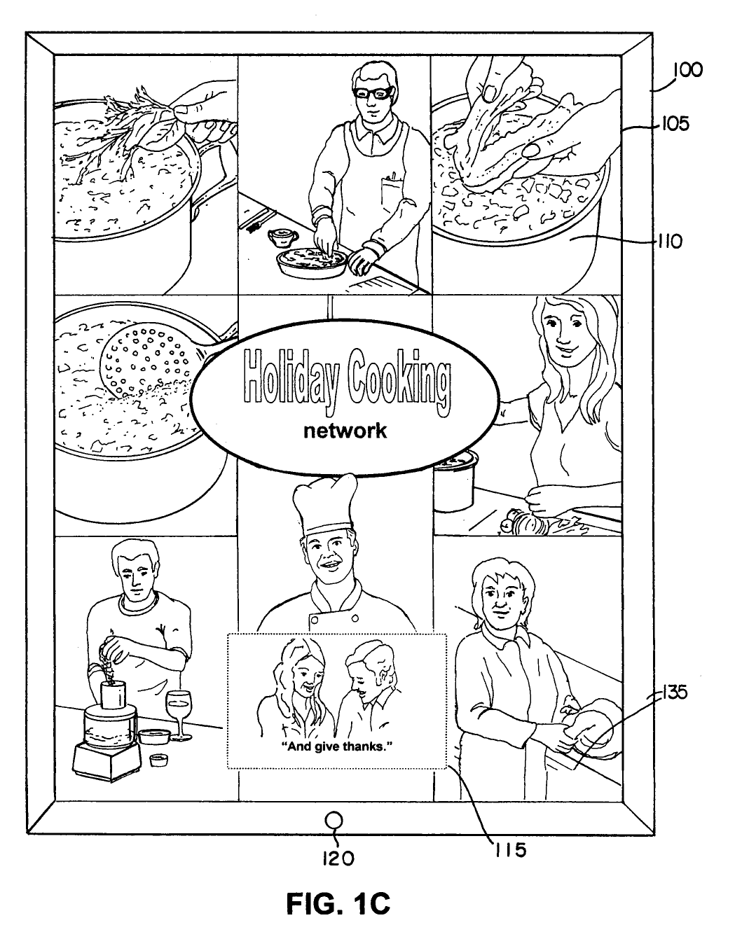

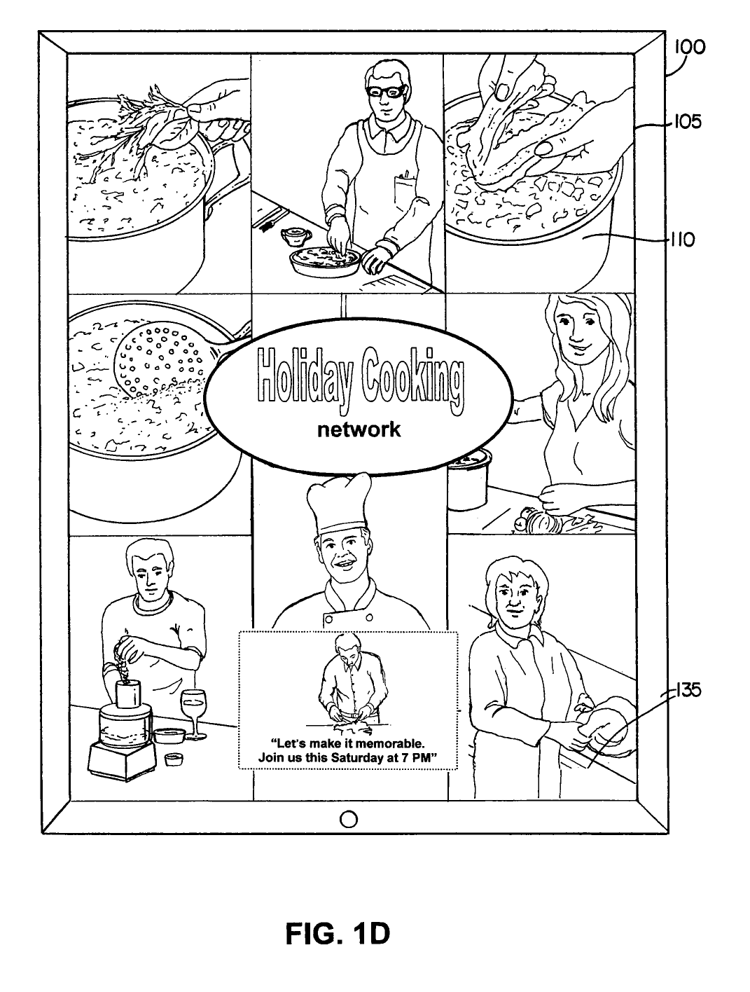

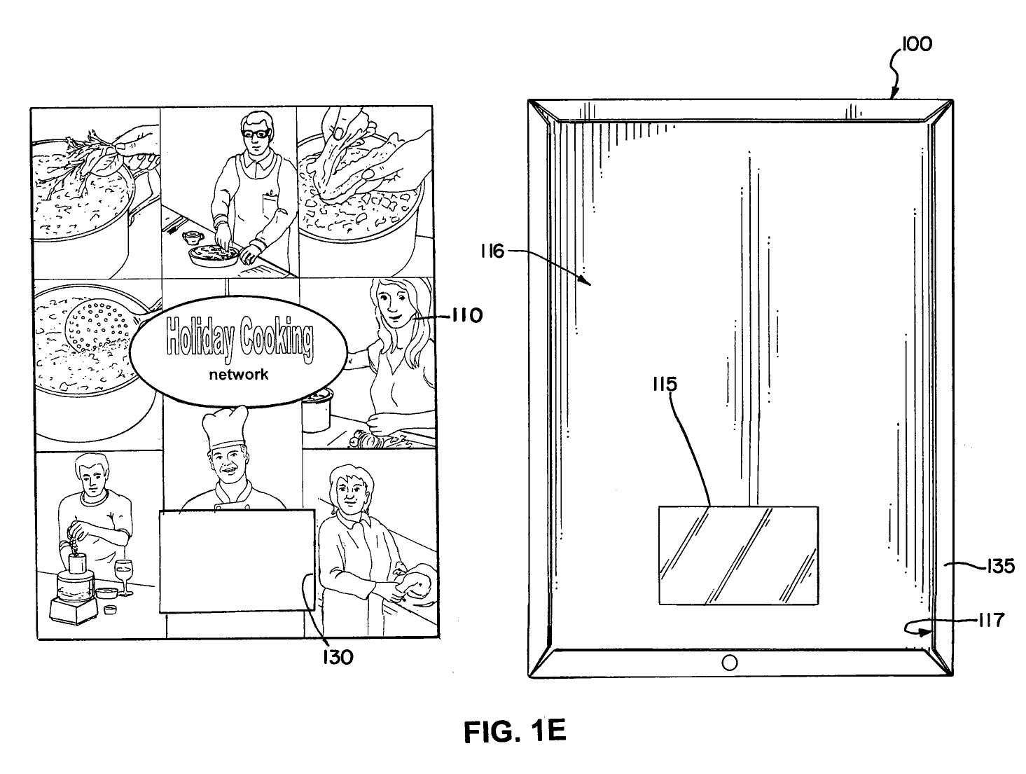

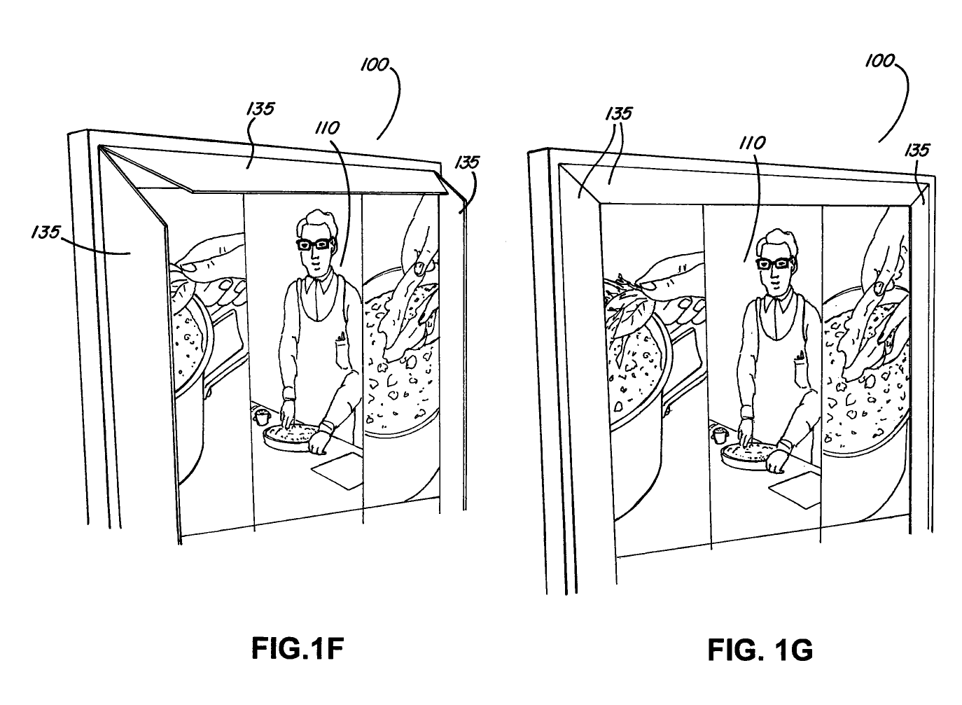

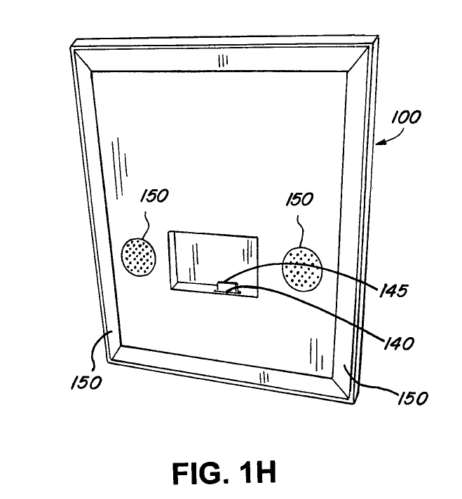

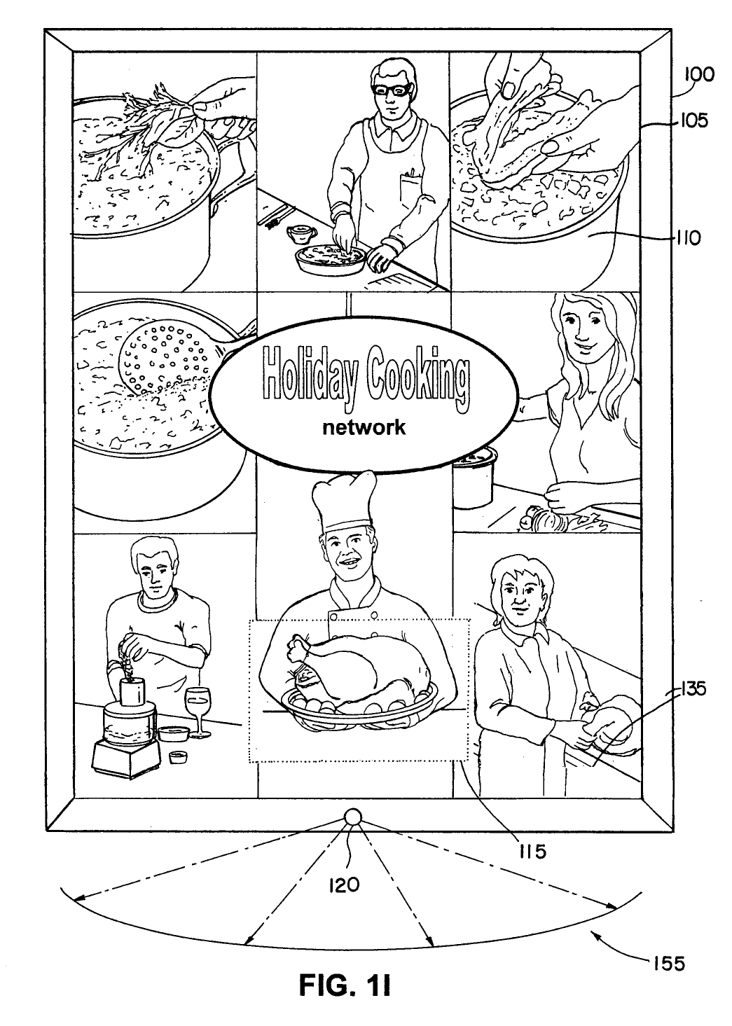

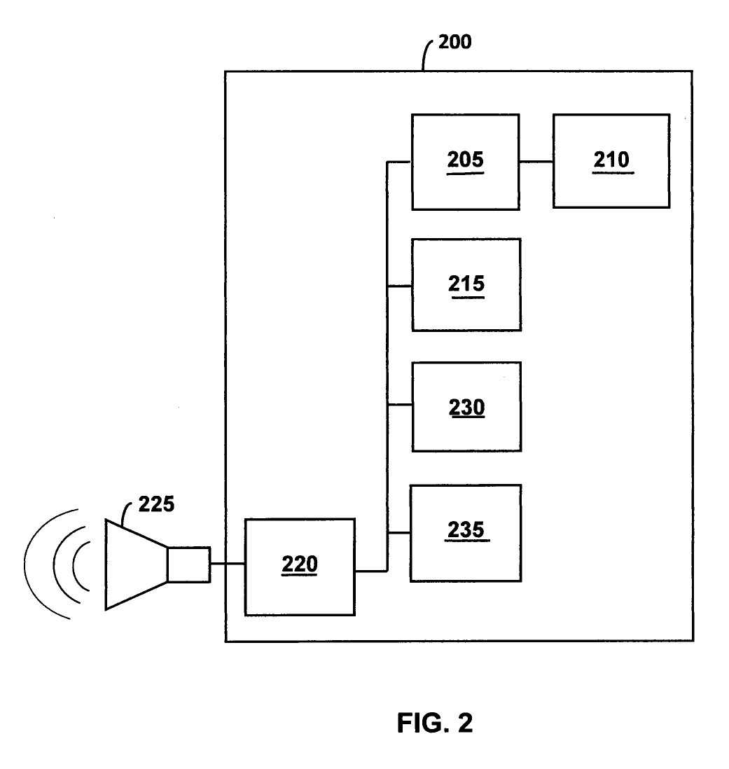

Referring now to FIG. 1 A, a picture frame 100 includes a frame portion 105 for holding a printed picture 110. In one aspect, the printed picture 110 could be a printed photograph on photo paper, a poster, or any other printed display with a cut-out portion 130. The printed picture 110 can consist of multiple images and be somewhat translucent to allow a backlight (not shown) to illuminate the printed picture 110. The frame portion 105 can be further broken down into four frame panels or picture holding components 135 which are configured to be flipped “open” to insert or remove a printed picture or flipped “closed” to hold the picture in place. As shown in FIG. 1A, the picture holding components are in the “closed” position. The picture frame 100 could also include an electronic display portion 115 appearing through the cut-out portion of the printed picture 110, and a sensor 120. As shown, the electronic display portion 115 is displaying a still picture. More particularly, the electronic display portion 115 is displaying the “missing” portion of the printed picture 110, whereby the remaining portion of a person holding up a turkey completes (i.e., “blends” into) the printed picture. Accordingly, a viewer approaching the picture might not suspect that the electronic display portion 115 is different than the rest of the printed picture 110. However, as the viewer moves closer to the picture frame 100 and triggers the sensor 120, the electronic display portion stops displaying the still portion (e.g., the person holding the turkey) and begins to play a video instead in the electronic display portion 115. In one example, the video could include an advertisement video for a Thanksgiving cooking show. The video could include slogans related to Thanksgiving, cornucopias, and the like.

FIG. 1B illustrates a snapshot of the video. As shown, the electronic display portion 115 is no longer displaying the “turkey” still picture of FIG. 1A, but instead, is now displaying a video including a portion of the video showing a family gathering around a Thanksgiving feast and the message “Thanksgiving is a time to gather”. In one aspect, the printed picture 110 remains the same and unchanged.

FIG. 1C illustrates another snapshot of the video at a later time period than FIG. 1B. As shown, the electronic display portion 115 is no longer displaying the “turkey” still picture of FIG. 1 A or the “family” video snapshot of FIG. 1B, but instead, is now displaying a video including a portion of the video showing family members laughing with one another and the message “And give thanks”. In one aspect, the printed picture 110 remains the same and unchanged.

FIG. 1D illustrates another snapshot of the video at a later time period than FIG. 1 C. As shown, the electronic display portion 115 is no longer displaying the “turkey” still picture of FIG. 1A, the “family” video snapshot of FIG. 1B, or the “laughing family” video snapshot of FIG. 1C, but instead, is now displaying a portion of the video showing a chef carving a turkey and the message “Let's make it memorable. Join us this Saturday at 7 PM.” In one aspect, the printed picture 110 remains the same and unchanged. Following the end of the video, the electronic display portion 115 stops playing the video and return to displaying the still picture of the “turkey” as shown in FIG. 1A.

FIG. 1E illustrates the picture frame 100 with “opened” frame pieces 135 which function as a picture holding component when the frame panels are in the “closed” position. Here, the electronic display portion 115 of the picture frame 100 is shown separate from the printed picture 110. The printed picture 110 can have the cut-out portion 130 such that when the still picture 110 is placed inside the picture frame 100 and the frame panels 135 are “closed” to hold the still picture in place inside the picture frame 100, the electronic display portion 115 is visible and coincide locationally with the cut-out portion 130. In addition, the picture frame 100 can include a translucent base or layer which provides structural support (e.g., for holding the picture 110 in place) while also allowing backlights 117 located behind the translucent layer 116 (e.g., at the edge of the frame or in an array behind the translucent layer 116) to shine through to brighten the picture 110. The translucent layer 116 enables the one or more lights to provide brightness to the picture 110 such that the picture 110 appears to be substantially equal in brightness to the electronic display portion 115. FIG. 1F illustrates a close-up, perspective view of three of the frame panels 135 which are flipped “open” to enable the insertion or removal of the printed picture 110. FIG. 1G illustrates a close-up, perspective view of three of the frame panels 135 that are in a “closed” position to hold the printed picture 110 in place. Prior FIGS. 1A-1D similarly illustrate the four frame panels 135 in a “closed” position. In this manner, when the printed picture 110 is inserted into the picture frame 100, the printed picture 110 and the electronic display portion 115 can form a “complete” picture.

FIG. 1H is a back view of the picture frame 100, which includes a media input unit 140 and a removable media storage device 145 containing media data that can be displayed on the electronic display portion 115 (not shown). FIG. 1H also illustrate speakers 150 which can be included in the picture frame 100 to output audio content separate from or in conjunction with the still image or video displayed on the electronic display portion 115.

FIG. 1I illustrates an example of the picture frame 100 with the sensor 120 and a corresponding sensor trigger zone 155. Although the sensor 120 is shown on the frame portion 105 for illustrative purposes, the sensor 120 can be positioned elsewhere, such as within the area of the printed picture 110, on the electronic display portion 115, and the like. More than one sensor can be used and any one of a number of sensor types can be utilized. For example, an ultrasonic sensor or a microwave sensor for object detection based on reflected microwaves can be used. U.S. Pat. No. 7,167,008 to Tsuji describes one such microwave sensor, and is fully incorporated herein by reference.

The sensor 120 can detect the presence, absence, or movement of one or more persons within a predetermined distance from the sensor 120. The predetermined distance can be any desirable distance from the front of the sensor 120 and/or to a side of the sensor 120 (e.g., 3-7 feet) and for example, can correspond with how far a normal human being can see a video being displayed in the electronic display 115. In one embodiment, the sensor 120 can be a distance and direction sensor to determine not only that a viewer is close by, but whether the viewer is walking closer to or farther away from the picture frame. If the viewer is walking closer, it can be assumed that the viewer is interested in the video and the video can keep playing or even repeat. However, if the viewer is determined to be walking away, the video might stop playing and return to the still picture. In an embodiment, the sensor trigger zone 155 can be any distance and/or any angle such that a person would be able to see the picture frame. A person's entry, exit, or continued presence within the sensor trigger zone 155 could also trigger the sensor 120.

FIG. 2 illustrates a block diagram of an electronic control system 200. In one embodiment, the electronic control system 200 controls the operation of the electronic display. The electronic control system 200 can include an audio/visual (A/V) controller 205. In one aspect, the A/V controller 205 is a processor or microprocessor. The A/V controller 205 can be configured to control the operation of the electronic display 115. Moreover, as shown, the A/V controller 205 can be coupled to a sensor 210, a memory 215, and audio output unit 220. The sensor 210 is configured to sense when a viewer moves within the sensor trigger zone 155 and sends a signal to the A/V controller 205 in response thereto.

In one aspect, when the A/V controller 205 receives a signal from the sensor 210 that a viewer has entered the sensor trigger zone 155, the A/V controller 205 sends a signal to an image output unit 235 to stop displaying the still image and the same or different signal is sent to a video output unit 230 to begin displaying a video. After a video has been played or the viewer is no longer sensed to be nearby, the A/V controller 205 instructs the video output 230 to stop playing the video and instructs the image output unit 235 to once again display the still image.

The memory 215 can be a physical memory such as random access memory (RAM), read-only memory (ROM), flash memory, a hard drive and the like. In one aspect, the memory 215 is comprised of two separate and different memories (not shown), a first memory for storing the instructions for the A/V controller operating the electronic display 115 and a second memory for storing still picture, video, and/or audio files.

The audio output unit 220 can be coupled to a speaker 225 and configured to output an audio in correspondence with a video being displayed. For example, the audio can be a verbal message, a song, and the like. In addition, the audio volume is controllable by the audio output unit 220 in a manner that decreases the volume as the viewer gets closer to the picture frame 100 as detected by sensor 210. Alternatively, the audio volume could be left constant and unrelated to the location of the viewer.

The video output unit 230 can be coupled to the A/V controller 205 and the memory 215 such that in response to receiving a signal to play the video, the video output unit 230 can retrieve the video data from the memory 215 and output the video signal to be displayed by the electronic display portion (e.g., the electronic display portion 115 of FIGS. 1A-E).

The image output unit 235 can be coupled to the A/V controller 205 and the memory 215 such that in response to receiving a signal to display the still picture, the image output unit retrieves the image data from the memory 215 and outputs the image signal to be displayed by the electronic display portion (e.g., electronic display portion 115 of FIGS. 1A-1E). Alternatively, the image data is stored in the image output unit 235. In one aspect, the video output unit 230 and the image output unit 235 could be replaced by a display control unit (not shown) configured to output either a still image or a motion video.

The electronic display portion 115 can be any of a plurality of known electronic display types such as an LCD, a light emitting diode (LED) display, or any other electronic display capable of visual output. The electronic display 115 may be detachably attached to the picture frame 100 and can be any desirable size and placed anywhere in the interior of the picture frame 100.

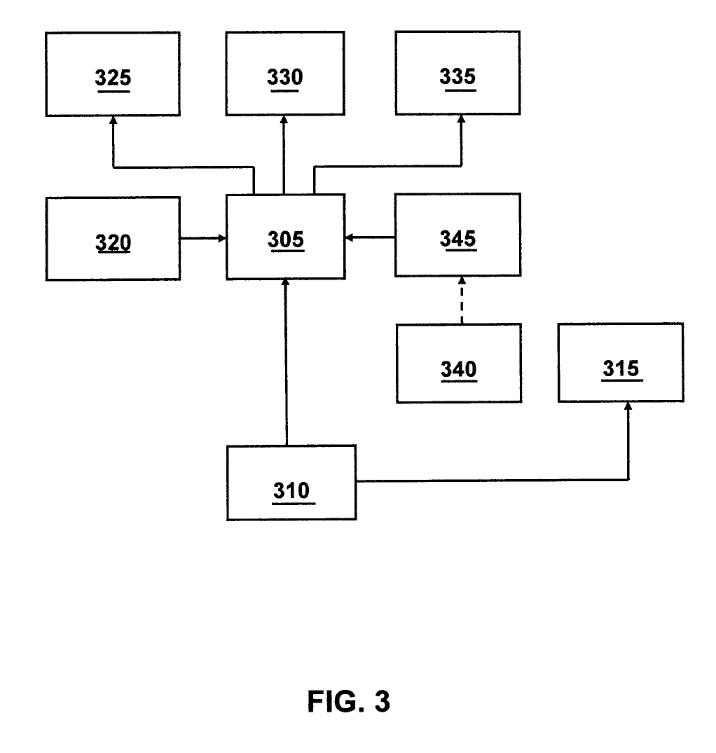

FIG. 3 illustrates another embodiment of a block diagram of an electronic control system. The electronic control system can include a CPU board 305, which controls operation of the electronic display portion 115 of FIGS. 1A-1D. The CPU board 305 is shown coupled to an internal or external power supply 310, which may in turn, be coupled to an edge-lit display 315 (e.g., backlight of the printed picture 110) or other illuminating light. The CPU board 305 can also be coupled to a sensor module 320, an LCD monitor 325, a speaker 330, and a micro USB 335, the latter of which can contain the initial programming and content for the electronic display portion 115 (e.g., still picture, video, and/or audio files). The sensor module 320 can be configured to sense when a viewer moves within a predetermined distance of the sensor module 320 and in response, sends a signal to the CPU board 305.

If the sensor module 320 does not detect the presence of a viewer within the sensor trigger zone (e.g., the sensor trigger zone 155 of FIG. 1I), the LCD monitor 325 remains in a standby state, such that the LCD monitor 325 displays the still image that completes the printed picture 110 (and/or corresponding audio content). Upon receiving a signal from the sensor module 320 that a viewer has entered the sensor trigger zone, the CPU board 305 retrieves the appropriate video and/or audio file from the micro USB 335 and outputs the video content to the LCD monitor 325 and the audio content to the speaker 330. When the sensor module 320 detects the absence of viewers remaining in the sensor trigger zone, the CPU board 305 instructs the LCD monitor 325 either immediately or after a certain period has elapsed (e.g., 30 seconds following the last detection of a viewer in the sensor trigger zone) to return to its standby state and display the still image. The CPU board 305 can also output a different audio file to the speaker 330 during this standby state. In another embodiment, the sensor module 320 detects whether a viewer is approaching the picture frame 100 or is moving away from the picture frame 100. If the latter instance occurs, for example, the CPU board 305 can instruct the LCD monitor 325 to discontinue the display of the video and return to its standby state.

The CPU board 305 might be controlled by a remote control 340 by way of an infrared receiver 345. The remote control 340 could be used, for example, to adjust the brightness of the LCD monitor 325 and/or the edge-lit display 315, the volume of the audio output, and so forth. The remove control 340 could also be used to turn “off” the edge-lit display 315 when it otherwise might be constantly turned “on” (e.g., during the daytime, when the printed picture 110 is better viewed without illumination). Moreover, the remote control 340 can also override certain defaulted settings (e.g., instruct the LCD monitor 325 to continue to play the video even if the sensor module 320 does not detect the presence of a viewer within the sensor trigger zone 155) or be used to scroll through a number of video and/or audio files stored on the micro USB 335 and enable the selection of a particular video and/or audio file for output on the LCD monitor 325 and/or speaker 330.

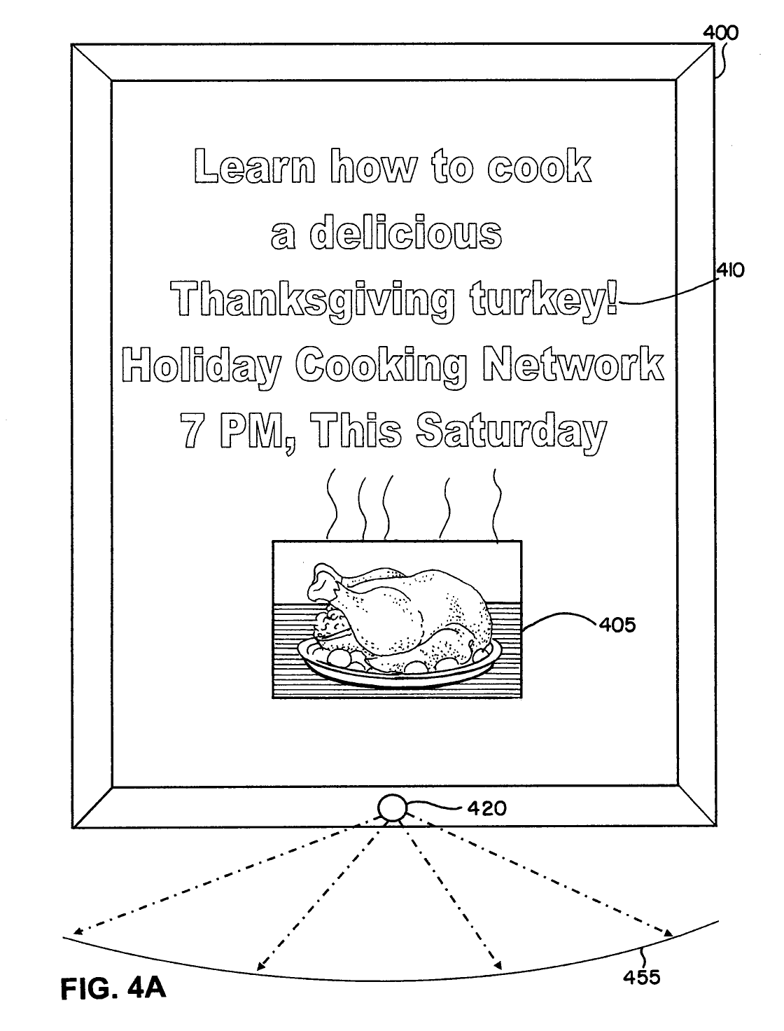

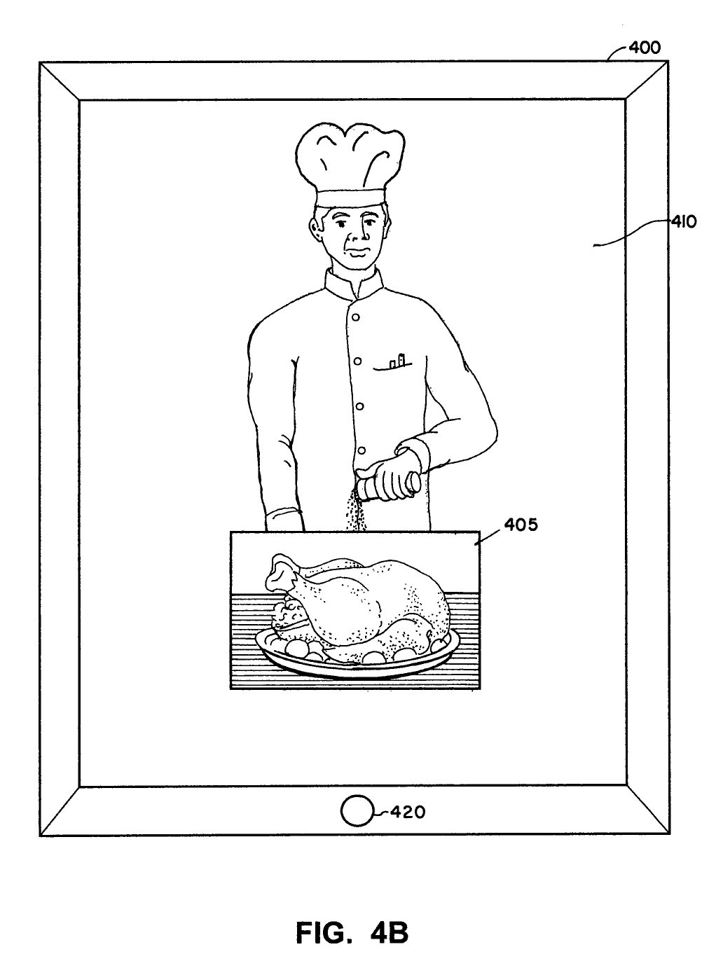

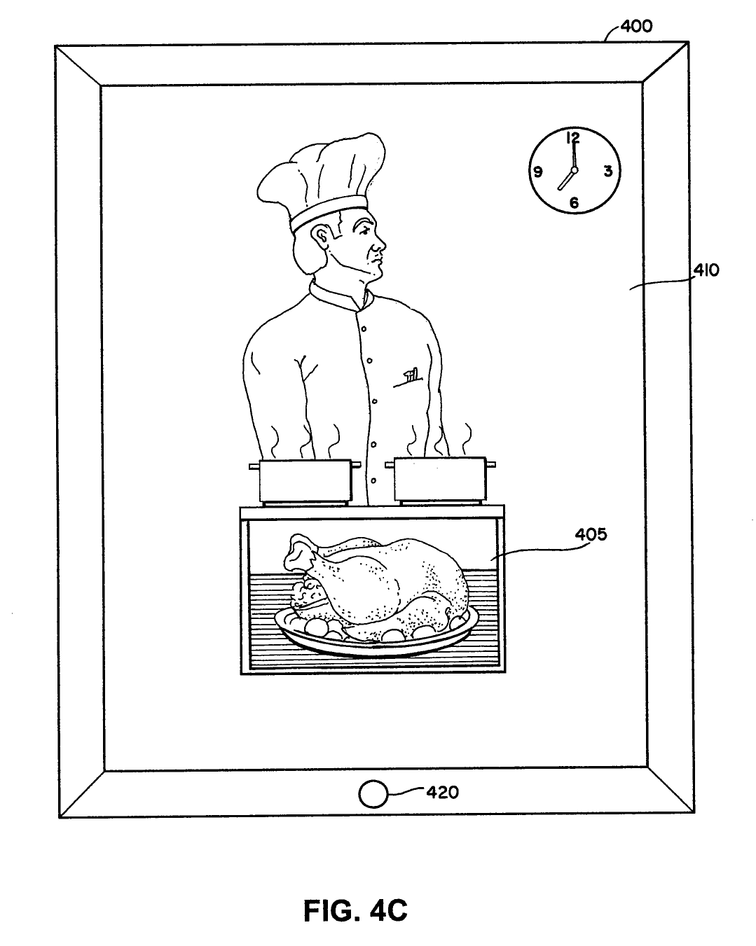

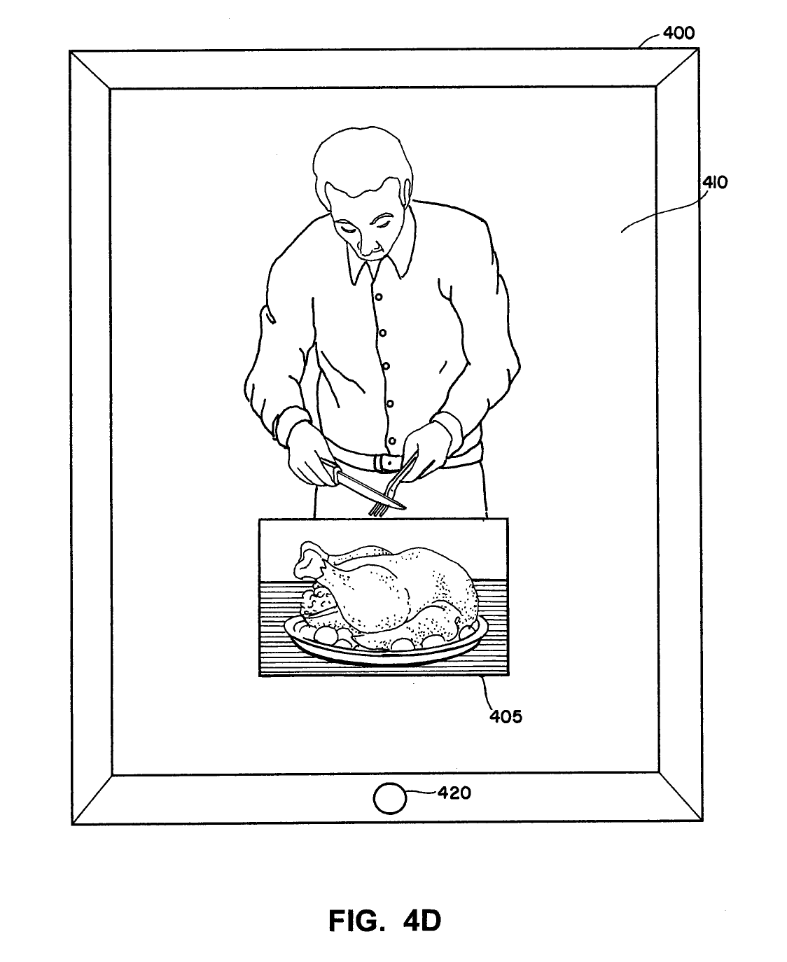

In one alternative, instead of using a printed picture, the picture frame 400 includes two display portions, 405 and 410. FIG. 4A is an example of a frame with a first display portion 405 and a second display portion 410. In this embodiment, the printed picture of FIG. 1A is replaced by another display portion (e.g., the second display portion 410). As shown, the first display portion 405 can be a LCD display embedded within a second display portion 410, which in one example, is also a LCD display. However, any of a number of electronic displays are interchangeable (e.g., LED, OLED, etc.). In one example, the visual output of the first display portion 405 might not change, while the second display portion 410 changes from displaying a still picture to a video upon a sensor 420 detecting the presence of a viewer within a sensor detecting range 455. Conversely, the second display portion 410 can output the same image, while the first display portion 405 can change from displaying a still picture to a video. The placement of the sensor 420 can be anywhere on or within the area of the picture frame 400. In one aspect, any sensor capable of detecting an approaching viewer can be used, including a microwave sensor described herein. FIGS. 4B-4D are snapshots of the picture frame 400 with the two display portions 405 and 410. More particularly, as shown, FIGS. 4B-4D show different shots of the video being played in the second display portion 410 when a viewer is within the sensor trigger range 455. As shown, the image projected in the first display portion 405 does not change, while the video is being played in the second display portion 410. In one alternative, the still picture as shown in FIG. 4A (comprising the first display portion 405 and the second display portion 410) can be “blended” or appear as one picture. However, a plurality of “blended” picture sets may be stored by the memory (e.g., memory 215 of FIG. 2, micro USB 335 of FIG. 3). Each “blended” picture set could have a distinctive video that is played when a viewer triggers the sensor 420. In one aspect, the different “blended” picture sets is scrolled based on a schedule. In this manner, the picture frame 400 is advantageously used to advertise for a number of different companies or products, with each company or product having one or more “blended” picture sets.

In one embodiment, the block diagrams of FIG. 2 and FIG. 3 could be used to control the first display portion 405 and the second display portion 410, and can be modified to include a second video or image output unit for the embodiment illustrated in FIG. 2, or an additional LCD monitor for the embodiment illustrated in FIG. 3. For example, the image output unit 235 of FIG. 2 can be further configured to display a still image in the first display portion 405 along with a still image (or video) in the second display portion 410. Similarly, the CPU board 305 of FIG. 3 can control both the first display portion 405 and the second display portion 410. Alternatively, a different component altogether can control the operation of the second display portion 410.

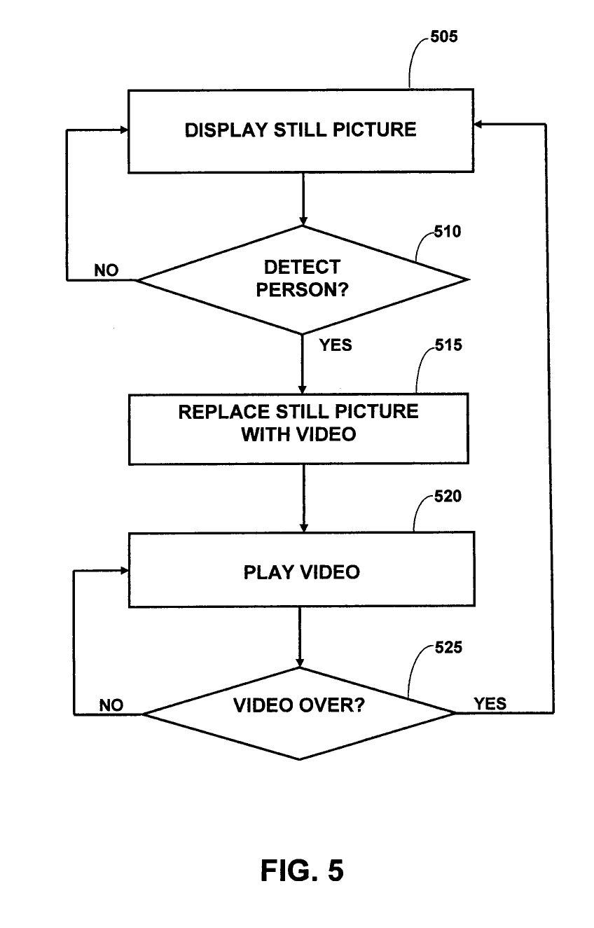

FIG. 5 illustrates a flow chart describing one method of operation of the picture frame 100 or 400. At step 505, a still image or picture is displayed by an electronic display (e.g., electronic display portion 115 of FIG. 1A). At step 510, the picture frame 100 detects whether a viewer is approaching the picture frame and is within a sensor trigger zone (e.g., sensor trigger zone 155 of FIG. 1I). If no viewer is detected, the still image or picture continues to be displayed in the electronic display and the entire picture looks whole. However, if at step 510, the picture frame 100 detects that a viewer is within the sensor trigger zone (e.g., by using sensor 120 of FIG. 1A), the picture frame 100 stops displaying the still image or picture and replaces it with a motion video. In one embodiment, audio is also outputted in conjunction with the motion video. At step 520, the video is played to the approaching viewer. Accordingly, the viewer may be surprised that what appeared to be a complete and still picture actually contains a portion that is now displaying a video. The video might not allow the entire picture to look whole when the video is playing and, in one aspect, could be unrelated to the subject matter of picture. However, as the video is configurable and may be designed to be any video, the video may still allow the entire picture to look whole, but just “moving” and no longer “still”. Once the playback of the video is complete as determined by step 525, the still image is reinserted until the picture frame 100 detects another viewer present within the sensor trigger zone. In another embodiment, the video can be continuously replayed until the sensor no longer detects the presence of a viewer within the sensor trigger zone.

Those of ordinary skill would appreciate that the various illustrative logical blocks, modules, and algorithm steps described in connection with the examples disclosed herein may be implemented as electronic hardware, computer software, or combinations of both. Furthermore, the present invention can also be embodied on a machine readable medium causing a processor or computer to perform or execute certain functions.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The various illustrative logical blocks, units, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A picture display system comprising:
a picture frame having a picture-holding component;
a picture configured to be held in place within the picture frame by the picture-holding component, the picture having a cut-out portion;
an electronic display portion attached to the picture frame at the location of the cut-out portion; and
a sensor coupled to the electronic display portion, the sensor configured to detect a presence of a person within a detection range of the sensor,
wherein the electronic display portion is configured to display a video when the sensor detects the presence of the person within the detection range, and the electronic display portion is configured to display a still image when the sensor does not detect the presence of a person within the detection range.

2. The system of claim 1, further comprising a speaker that outputs audio when the sensor detects the presence of the person within the detection range.

3. The system of claim 1, wherein the sensor is further configured to determine a direction of movement of the person within the detection range, and wherein the electronic display portion is configured to display the still image when the sensor determines that the direction of movement of the person is away from the sensor.

4. The system of claim 1, wherein the picture holding components include four adjustable frame portions, and wherein each of the four adjustable frame portions are configured to be manipulated between an open position which allows the picture to be removed, and a closed position which holds the picture in place.

5. The system of claim 1, wherein the still image completes the picture such that the still image and picture form a cohesive display.

6. The system of claim 1, further including an infrared receiver configured to receive commands for operating the electronic display portion from a remote control.

7. The system of claim 1, wherein the picture frame further includes a translucent layer separating one or more lights from the picture.

8. The system of claim 7, wherein the one or more lights to provide brightness to the picture such that the picture appears to be substantially equal in brightness to the electronic display portion.

9. An apparatus for camouflaging a portion of picture as a still image and replacing the still image with a video and upon detection of a person, the apparatus comprising:
a base for supporting a picture;
a frame attached to the edge of the base configured to hold the picture to the base;
an electronic display portion within the base;
a sensor coupled to the electronic display portion, the sensor configured to detect a presence of a person within a detection range of the sensor,
wherein the electronic display portion is configured to display the video when the sensor detects the presence of the person within the detection range, and wherein the electronic display portion is configured to display the still image when the sensor does not detect the presence of a person within the detection range.

10. The apparatus of claim 9, further comprising a speaker that outputs audio when the sensor detects the presence of the person within the detection range.

11. The apparatus of claim 9, wherein the sensor is further configured to determine a direction of movement of the person within the detection range, and wherein the electronic display portion is configured to display the still image when the sensor determines that the direction of movement of the person is away from the sensor.

12. The apparatus of claim 9, wherein the frame includes adjustable portions, and wherein each of the adjustable portions are configured to be manipulated between an open position which allows the picture to be removed, and a closed position which holds the picture in place.

13. The apparatus of claim 9, wherein the electronic display is visible through a cut-out portion of the picture when the picture is held in place by the frame.

14. The apparatus of claim 13, wherein the still image completes the picture such that the still image and picture form a cohesive display.

15. The apparatus of claim 9, further including an infrared receiver configured to receive commands for operating the electronic display portion from a remote control.

16. The apparatus of claim 9, wherein a portion of the base is a translucent layer.

17. The apparatus of claim 16, further including one or more lights positioned behind the translucent layer for providing brightness to a picture when the picture is held in place by the frame such that the picture appears to be substantially equal in brightness to the electronic display portion.

18. A method of replacing a still image with a video, comprising:
displaying a still image on an electronic display within a picture frame;
detecting a presence of a person using a sensor coupled to the electronic display;
in response to detecting the presence of a person, replacing the still image on the electronic display with the video; and
playing the video on the electronic display until the video is over or until the sensor determines that the person is no longer present.

19. The method of claim 18, further comprising:
returning the display to displaying the still image when the video is over or when the sensor determines that the person is no longer present.

20. The method of claim 18, wherein displaying a still image on an electronic display within a picture frame provides a cohesive picture with another portion of a physical picture held in place within the picture frame.
